(19) United States
(12) Patent Application Publication
(10) Pub. No.: US 2020/0086291 A1
(43) Pub. Date: Mar. 19, 2020

(54) PLASMA TREATMENT APPARATUS

(71) Applicants: SUMITOMO RIKO COMPANY LIMITED, Komaki-shi (JP); NATIONAL UNIVERSITY CORPORATION NAGOYA UNIVERSITY, Nagoya-shi (JP)

(72) Inventors: Kensuke SASAI, Nagoya-shi (JP); Hirotaka TOYODA, Nagoya-shi (JP)

(73) Assignees: SUMITOMO RIKO COMPANY LIMITED, Komaki-shi (JP); NATIONAL UNIVERSITY CORPORATION NAGOYA UNIVERSITY, Nagoya-shi (JP)

(21) Appl. No.: 16/689,241

(22) Filed: Nov. 20, 2019

Related U.S. Application Data
(63) Continuation of application No. PCT/JP2018/031005, filed on Aug. 22, 2018.

(30) Foreign Application Priority Data
Sep. 20, 2017 (JP) 2017-180128

(51) Int. Cl. B01J 19/12; H05H 1/46; C02F 1/30

(52) U.S. Cl. CPC B01J 19/126; H05H 1/46; C02F 1/302; H05H 2001/4622; B01J 2219/0877; B01J 2219/1293; B01J 2219/1269; B01J 2219/1227; B01J 2219/0896

(57) ABSTRACT

A plasma treatment apparatus which performs uniform plasma treatment on a liquid. A plasma treatment apparatus includes a coaxial waveguide having an inner conductor, a first outer conductor, and a second outer conductor; a microwave generation unit; an outside tube which is located on the outer side of the first outer conductor and the second outer conductor and which in cooperation with the first outer conductor and the second outer conductor forms a flow path through which a liquid flows; and a plasma generation region. A first protrusion of the first outer conductor and a second protrusion of the second outer conductor face each other in a non-contacting state. The plasma generation region is a region extending along a facing location where the first protrusion of the first outer conductor and the second protrusion of the second outer conductor face each other.

### TECHNICAL FIELD

The technical field of the present specification relates to a plasma treatment apparatus which applies plasma to a liquid.

### BACKGROUND ART

Plasma technology has been applied to the fields of electricity, chemistry, and materials. Plasma generates radicals and ultraviolet rays which are high in chemical reactivity, as well as electrons and positive ions. Radicals are used for, for example, film formation and etching of semiconductors. Ultraviolet rays are used for, for example, sterilization. Such plentiful matters originating from plasma have expanded the range of fields in which plasma technology is put into practice.

A device in which microwaves are used for generation of plasma exists. For example, Patent Document 1 discloses a technique of using microwave plasma for plasma treatment of a liquid such as wastewater. Patent Document 1 discloses a technique of causing microwaves to propagate in a direction orthogonal to a flow direction of a liquid to be treated. Plasma is generated around a flow path having an annular cross section.

### PRIOR ART DOCUMENT

### Patent Document

Patent Document 1: Japanese Patent Application Laid-Open (kokai) No. 2015-050010

### SUMMARY OF THE INVENTION

### Problem to be Solved by the Invention

In the technique of Patent Document 1, plasma rises easily at a position of a 0° direction in which microwaves enter the annular flow path, and plasma does not rise easily at a position of a 180° direction in which the microwaves leave. Namely, despite the desire to generate circular plasma in an annular region around the flow path, semi-circular plasma may be generated. Even in the case where circular plasma is generated, there arises a phenomenon in which the intensity of plasma increases at a position corresponding to the incident direction of microwaves (0° direction). The technique of Patent Document 1 encounters difficulty in performing uniform plasma treatment on a liquid.

The technique of the present specification has been accomplished so as to solve the problem of the above-described conventional technique. Namely, its object is to provide a plasma treatment apparatus which performs uniform plasma treatment on a liquid.

### Means for Solving the Problem

A plasma treatment apparatus according to a first mode comprises a coaxial waveguide which includes an inner conductor, a first outer conductor located on the outer side of the inner conductor and having a first end portion, and a second outer conductor located on the outer side of the inner conductor and having a second end portion; a microwave generation unit which generates microwaves to be propagated to the coaxial waveguide; an outside tube which is located on the outer side of the first outer conductor and the second outer conductor and which in cooperation with the first outer conductor and the second outer conductor forms a flow path through which liquid flows; and a plasma generation region in which plasma is generated. The first end portion of the first outer conductor and the second end portion of the second outer conductor face each other in a non-contacting state. The plasma generation region is a region extending along a facing location where the first end portion of the first outer conductor and the second end portion of the second outer conductor face each other.

This plasma treatment apparatus can generate uniform annular plasma. The term “annular” encompasses a circular shape and the shape of a ring having a polygonal cross section. Since uniform plasma can be generated, plasma treatment can be performed uniformly on the liquid flowing through the flow path. Also, the liquid can be plasma-treated continuously in line rather than through batch treatment.

### Effect of the Invention

In the present specification, a plasma treatment apparatus which performs uniform plasma treatment on a liquid is provided.

### BRIEF DESCRIPTION OF THE DRAWINGS

FIG. 1 View schematically showing the structure of a plasma treatment apparatus of a first embodiment.

FIG. 2 Sectional view of the plasma treatment apparatus of the first embodiment showing an area around a facing location where a first outer conductor and a second outer conductor face each other.

FIG. 3 First sectional view of a plasma treatment apparatus of a modification of the first embodiment showing an area around the facing location where the first outer conductor and the second outer conductor face each other.

FIG. 4 Second sectional view of a plasma treatment apparatus of another modification of the first embodiment showing an area around the facing location where the first outer conductor and the second outer conductor face each other.

### MODES FOR CARRYING OUT THE INVENTION

Specific embodiments will now be described with reference to the drawings, with a plasma treatment apparatus for applying plasma to a liquid being used as an example.

### First Embodiment

### 1. Plasma Treatment Apparatus

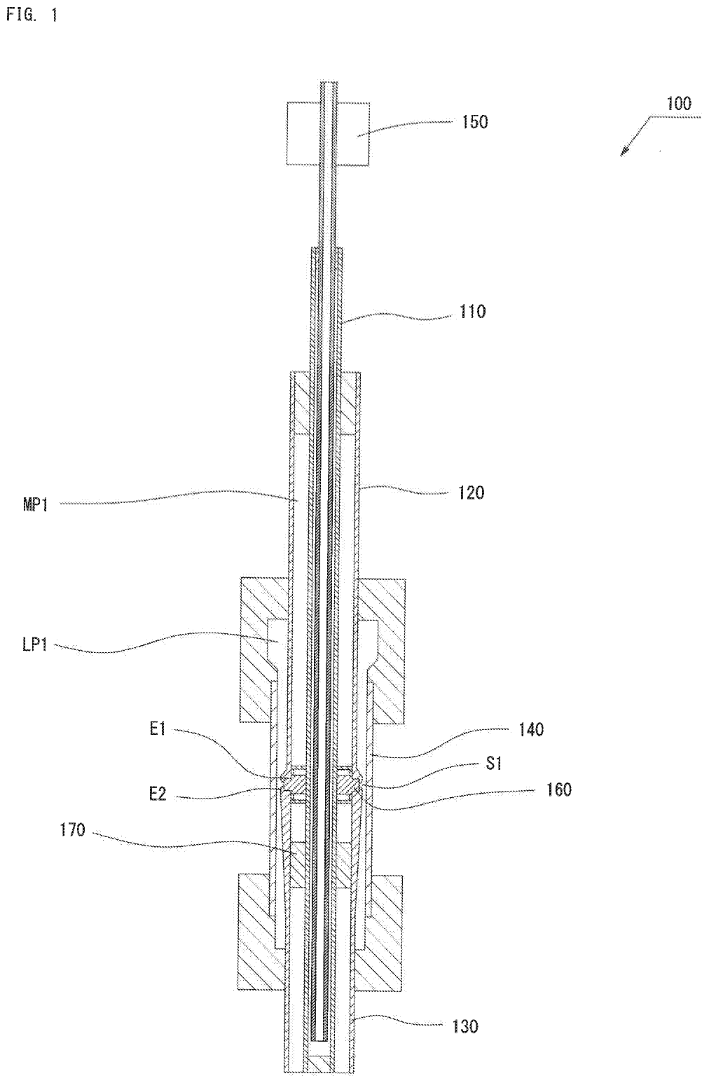

FIG. 1 is a view schematically showing the structure of a plasma treatment apparatus 100 of a first embodiment. The plasma treatment apparatus 100 generates plasma by using a waveguide for guiding microwaves. The plasma treatment apparatus 100 includes an inner conductor 110, a first outer conductor 120, a second outer conductor 130, an outside tube 140, a microwave generation unit 150, a dielectric member 160, and a short plunger 170.

The plasma treatment apparatus 100 includes a coaxial waveguide having the inner conductor 110, the first outer conductor 120, and the second outer conductor 130. Therefore, the inner conductor 110, the first outer conductor 120, the second outer conductor 130 share a common center axis. As shown in FIG. 1, microwaves propagate in a space MP1 between the inner conductor 110 and the first outer conductor 120 and the second outer conductor 130.

The inner conductor 110 serves as an inner waveguide of the coaxial waveguide. Therefore, the inner conductor 110 is disposed on the inner side of the first outer conductor 120 and the second outer conductor 130. The inner conductor 110 has a cylindrical tubular shape. The material of the inner conductor 110 is copper, brass, or any of other metals. The surface of the inner conductor 110 may be plated.

The first outer conductor 120 is an outer waveguide of the coaxial waveguide. Therefore, the first outer conductor 120 is disposed on the outer side of the inner conductor 110. The first outer conductor 120 has a first end portion E1. The first end portion E1 is one of the two longitudinal end portions of the first outer conductor 120. The first outer conductor 120 has an approximately cylindrical tubular shape. The material of the first outer conductor 120 is copper, brass, or any of other metals. The surface of the first outer conductor 120 may be plated.

The second outer conductor 130 is an outer waveguide of the coaxial waveguide. Therefore, the second outer conductor 130 is disposed on the outer side of the inner conductor 110. The second outer conductor 130 has a second end portion E2. The second end portion E2 is one of the two longitudinal end portions of the second outer conductor 130. The second outer conductor 130 has an approximately cylindrical tubular shape. The material of the second outer conductor 130 is copper, brass, or any of other metals. The surface of the second outer conductor 130 may be plated.

The outside tube 140 is disposed on the outer side of the first outer conductor 120 and the second outer conductor 130. The outside tube 140 forms, in cooperation with the first outer conductor 120 and the second outer conductor 130, a flow path LP1 through which a liquid flows. The outside tube 140 has a cylindrical tubular shape. The center axis of the outside tube 140 is common with the center axis of the inner conductor 110, the first outer conductor 120, and the second outer conductor 130. The material of the outside tube 140 is, for example, glass.

The microwave generation unit 150 is a device for generating microwaves. The microwaves propagate along the coaxial waveguide. The microwave generation unit 150 is, for example, a magnetron. The microwave generation unit 150 may have an additional device such as an isolator if necessary. The frequency of microwaves generated by the microwave generation unit 150 is, for example, 2.45 GHz. Needless to say, the frequency may be other than 2.45 GHz. These are mere examples, and the configuration of the microwave generation unit 150 may differ from the above-described configuration.

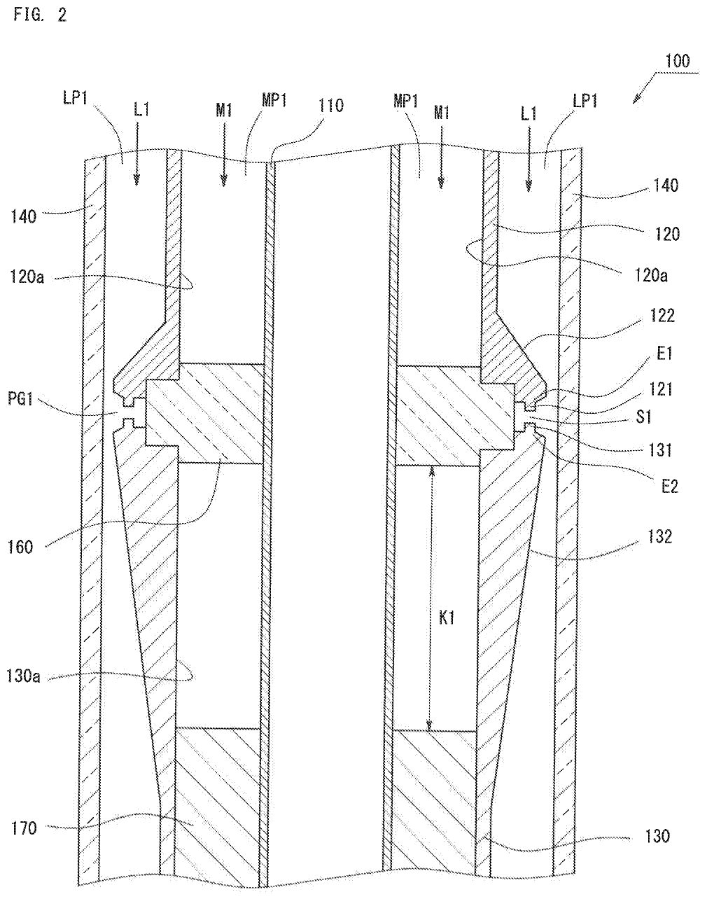

The dielectric member 160 allows a portion of the microwaves to pass therethrough and reflects the remaining portion. The dielectric member 160 is disposed in a region which extends along a facing location where the first protrusion 121 of the first outer conductor 120 and the second protrusion 131 of the second outer conductor 130 faces each other (see FIG. 2) and which extends inward from the facing location. The dielectric member 160 is disposed such that it extends from the first outer conductor 120 and the second outer conductor 130 to the inner conductor 110 and is held therebetween. The material of the dielectric member 160 is, for example, quartz tube or alumina. Needles to say, other materials may be used.

The short plunger 170 reflects the microwaves. The short plunger 170 is disposed in a state in which it is held between the inner conductor 110 and the second outer conductor 130. Through selection of the material of the dielectric member 160 and the distance between the dielectric member 160 and the short plunger 170, a standing wave can be generated in a space between the dielectric member 160 and the short plunger 170. Generation of such a standing wave facilitates excitation of plasma. Also, the excited plasma becomes stable. Notably, the short plunger 170 may slightly absorb a portion of the microwaves.

### 2. Location where the First Outer Conductor and the Second Outer Conductor Face Each Other

FIG. 2 is a sectional view showing an area around a facing location where the first outer conductor 120 and the second outer conductor 130 face each other. The first outer conductor 120 and the second outer conductor 130 are separate members. The first outer conductor 120 and the second outer conductor 130 face each other in a non-contacting state. The center axis of the first outer conductor 120 and the center axis of the second outer conductor 130 are common with the center axis of the inner conductor 110. The inner diameter of the first outer conductor 120 is equal to the inner diameter of the second outer conductor 130. The first outer conductor 120 and the second outer conductor 130 are disposed such that, when an inner surface 120a of the first outer conductor 120 is extended, it coincides with an inner surface 130a of the second outer conductor 130. However, the inner diameter of the first outer conductor 120 may slightly differ from the inner diameter of the second outer conductor 130.

### 2-1. Protrusion and Slit

As shown in FIG. 2, the first end portion E1 of the first outer conductor 120 and the second end portion E2 of the second outer conductor 130 face each other in a non-contacting state.

The first outer conductor 120 has the first protrusion 121. The first protrusion 121 is formed on the first end portion E1 which is one end surface of the first outer conductor 120. The first protrusion 121 protrudes from the first end portion E1 toward the second outer conductor 130. The first protrusion 121 has the shape of a circular ring. The center of the circular ring coincides with the center axis of the first outer conductor 120.

The second outer conductor 130 has the second protrusion 131. The second protrusion 131 is formed on the second end portion E2 which is one end surface of the second outer conductor 130. The second protrusion 131 protrudes from the second end portion E2 toward the first outer conductor 120. The second protrusion 131 has the shape of a circular ring. The center of the circular ring coincides with the center axis of the second outer conductor 130.

The first protrusion 121 and the second protrusion 131 face each other in a non-contacting state. Therefore, the first protrusion 121 and the second protrusion 131 defines a slit S1 therebetween. The slit S1 has a width of about 0.05 mm to 1 mm. The diameter of the circular first protrusion 121 is the same as the diameter of the circular second protrusion 131.

### 2-2. Plasma Generation Region

As shown in FIG. 2, the plasma treatment apparatus 100 has a plasma generation region PG1 for generating plasma. The plasma generation region PG1 extends along the slit S1. Namely, the plasma generation region PG1 is a region extending along the facing location where the first protrusion 121 of the first outer conductor 120 and the second protrusion 131 of the second outer conductor 130 face each other.

The plasma generation region PG1 may be wider than the width of the first protrusion 121 and the second protrusion 131. The plasma generation region PG1 is a region (facing location) where the first protrusion 121 of the first outer conductor 120 and the second protrusion 131 of the second outer conductor 130 face each other and which may contain a region on the outer side of the facing location. The plasma generation region PG1 is a region (facing location) where the first protrusion 121 of the first outer conductor 120 and the second protrusion 131 of the second outer conductor 130 face each other and which may contain a region on the inner side of the facing location.

Therefore, the “region extending along the facing location where the first protrusion 121 of the first outer conductor 120 and the second protrusion 131 of the second outer conductor 130 face each other” which is the plasma generation region PG1 is a region including a first region between the first protrusion 121 and the second protrusion 131 and regions located on the inner and outer sides, respectively, of the first region in the radial direction of the first outer conductor 120 and the second outer conductor 130. Namely, the plasma generation region PG1 is a region extending along a location where the first end portion E1 of the first outer conductor 120 and the second end portion E2 of the second outer conductor 130 face each other.

As described above, both the first protrusion 121 and the second protrusion 131 have a circular shape. Therefore, the plasma generation region PG1 also has a circular shape. Notably, there is no fear that the plasma generation region PG1 is inundated with the liquid flowing through the flow path LP1. Therefore, the plasma treatment apparatus 100 can Stably Generate Plasma During Plasma Treatment of the Liquid.

### 2-3. Sloping Surfaces

The first outer conductor 120 has a first sloping surface 122. The first sloping surface 122 protrudes from the periphery of the first outer conductor 120 toward the outside tube 140. The degree of protrusion of the first sloping surface 122 toward the outside tube 140 increases toward the first protrusion 121. Therefore, the flow path LP1 becomes narrower toward the first end portion E1. The first sloping surface 122 is formed to extend around the periphery of the first outer conductor 120.

The second outer conductor 130 has a second sloping surface 132. The second sloping surface 132 protrudes from the periphery of the second outer conductor 130 toward the outside tube 140. The degree of protrusion of the second sloping surface 132 toward the outside tube 140 increases toward the second protrusion 131. Therefore, the flow path LP1 becomes narrower toward the second end portion E2. The second sloping surface 132 is formed to extend around the periphery of the second outer conductor 130.

As described above, the flow path LP1 becomes narrower toward the plasma generation region PG1. Therefore, the flow speed of the liquid flowing through the flow path LP1 is very large in the vicinity of the plasma generation region PG1. As a result, at a location facing the plasma generation region PG1, the pressure of the liquid becomes very small. Specifically, the pressure of the liquid under the atmospheric pressure (1 atm) can be lowered to about 0.1 atm. The pressure in the plasma generation region PG1 can be set to a pressure within the range of 0.1 atm to 1 atm by adjusting the inclination of the first sloping surface 122, the inclination of the second sloping surface 132, and the width of the flow path LP1 in the vicinity of the plasma generation region PG1. Further, a lower pressure can be realized. As described above, the plasma treatment apparatus 100 utilizes the Venturi effect.

### 3. Operation of Plasma Treatment Apparatus

The liquid is supplied to the flow path LP1 in the direction of an arrow L1 of FIG. 2. In this stage, no plasma is generated in the plasma generation region PG1; however, the pressure in the vicinity of the plasma generation region PG1 drops.

Next, the microwave generation unit 150 generates microwaves, and the microwaves propagate along the coaxial waveguide. As a result, the microwaves propagate through the space between the first outer conductor 120 and the inner conductor 110 in the direction of an arrow Ml of FIG. 2. A portion of the microwaves passes through the dielectric member 160 and propagates toward the short plunger 170. As a result, a standing wave is generated in the space K1 between the dielectric member 160 and the short plunger 170.

Thus, the microwaves induce surface currents in the inner conductor 110, the first outer conductor 120, and the second outer conductor 130. As a result, a relatively strong electric field is applied between the first protrusion 121 and the second protrusion 131. Thus, discharge occurs between the first protrusion 121 and the second protrusion 131, and plasma is generated in the plasma generation region PG1.

As a result of generation of the plasma in the plasma generation region PG1, matters originating from the plasma are applied to the liquid flowing through the flow path LP1. The matters originating from the plasma include electrons, positive ions, radicals, and ultraviolet rays. As a result, the liquid flowing through the flow path LP1 is plasma treated.

### 4. Effects of Present Embodiment

The plasma treatment apparatus 100 of the present embodiment can generate uniform circular plasma. Therefore, plasma treatment can be performed uniformly for the liquid flowing through the flow path LP1. In the present embodiment, plasma can be generated under reduced pressure without use of a pressure reducing pump or the like. Also, the liquid can be plasma-treated continuously in line rather than batch processing.

The diameter of the plasma generation region PG1 in this plasma treatment apparatus 100 is sufficiently large. Accordingly, the diameter of the flow path LP1 is sufficiently large. Accordingly, the amount of liquid treated by the plasma treatment apparatus 100 per unit time is very large as compared with the conventional apparatus. Also, since the outside tube 140 which forms the flow path LP1 is transparent, an operator or the like can visually check the plasma. Also, the state of plasma treatment can be monitored by using a camera or the like.

### 5. Modifications

### 5-1. Dielectric Member

The plasma treatment apparatus 100 of the present embodiment has the dielectric member 160. However, the plasma treatment apparatus is not required to have the dielectric member 160.

### 5-2. Shape of Dielectric Member (Insulator)

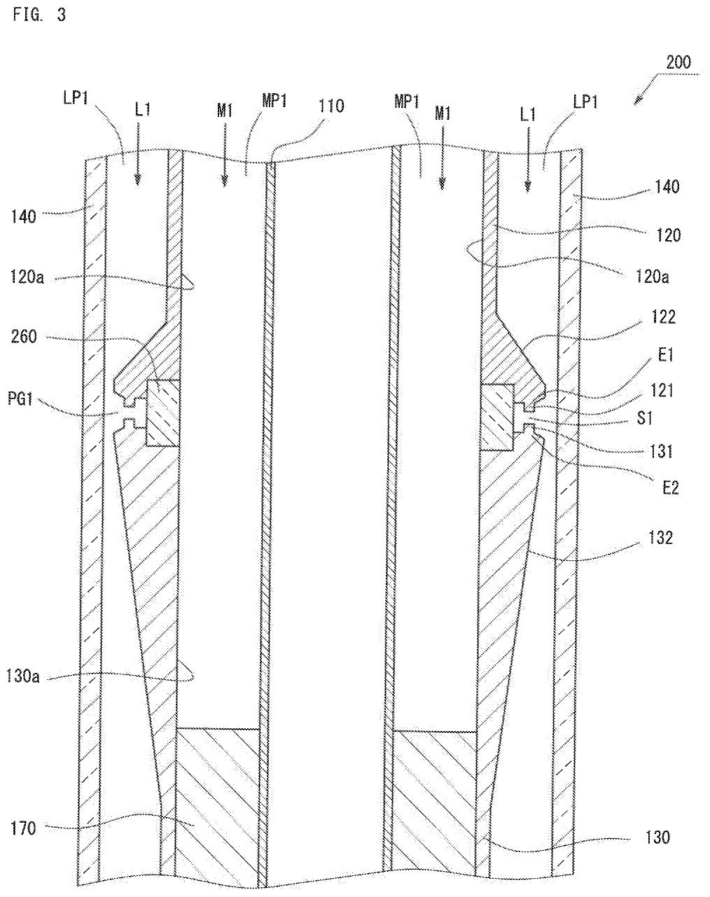

As shown in FIG. 3, in place of the dielectric member 160, an insulator 260 for insulating the first outer conductor 120 and the second outer conductor 130 from each other may be provided. The insulator 260 can insulate the first outer conductor 120 and the second outer conductor 130 from each other and prevent leakage of gas to the plasma generation region from the space inside the first outer conductor 120 and the second outer conductor 130. The insulator 260 is preferably disposed at a position determined such that the insulator 260 does not overlap the propagation region of microwaves.

### 5-3. Shape of Outside Tube

The outside tube 140 is not necessarily required to have a cylindrical tubular shape. The outside tube 140 is not required to have a fixed inner diameter as described above. It is sufficient for the liquid flow path LP1 to pass through only the location of the plasma generation region PG1. However, it is preferred that the direction of the center axis of at least one of the first outer conductor 120 and the second outer conductor 130 be parallel to the direction of the center axis of the outside tube 140.

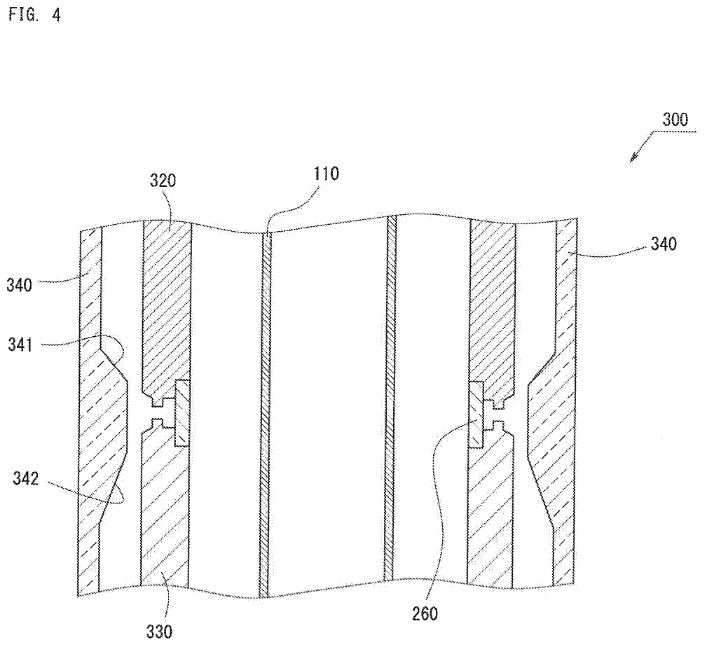

FIG. 4 is a view for describing a plasma treatment apparatus 300 in which, instead of the first outer conductor 320 and the second outer conductor 330, its outside tube 340 has a first sloping surface 341 and a second sloping surface 342. In this case, attention must be paid on the flow of the liquid in the vicinity of the plasma generation region PG1.

Also, each of the first outer conductor, the second outer conductor, and the outside tube may have a sloping surface. In the case, the liquid flow path is narrowed from both sides; i.e., the waveguide side and the outside tube side.

### 5-4. Material of Outside Tube

In the present embodiment, the material of the outside tube 140 is, for example, glass. However, a material other than glass (e.g., a metal or an insulator) may be used. However, in the vicinity of the plasma generation region PG1, the distance between the outside tube 140 and the first outer conductor 120 and the second outer conductor 130 is relatively small. Therefore, it is preferred that the outside tube 140 be an insulator. Also, it is preferred that the outside tube 140 be formed of a transparent material because plasma can be easily observed from the outside.

### 5-5. Shape of Waveguide

Each of the inner conductor 110, the first outer conductor 120, and the second outer conductor 130 has an approximately cylindrical tubular shape. However, each of the inner conductor 110, the first outer conductor 120, and the second outer conductor 130 may have a taper shape. Also, each of the inner conductor 110, the first outer conductor 120, and the second outer conductor 130 may have the shape of a tube having a polygonal cross section. In this case, it is preferred that the outside tube have a shape coincident with that of the waveguide.

### 5-6. Pump

In the present embodiment, the liquid spontaneously flows through the flow path LP1. However, the plasma treatment apparatus may include a pump for feeding the liquid. The pump can increase the flow speed of the liquid. Namely, the amount of the liquid treated at a time increases. Also, the pressure in the vicinity of the plasma generation region PG1 can be reduced further.

### 5-7. Operation Sequence of Plasma Treatment Apparatus

In the present embodiment, the microwaves are propagated to the space MP1 after the liquid has been supplied to the flow path LP1. However, the microwaves may be transmitted to the space MP1 before the liquid is supplied to the flow path LP1. This is because the plasma treatment apparatus 100 can generate plasma in the plasma generation region PG1 even under the atmospheric pressure.

Alternatively, the microwaves may be propagated to the space MP1 after a certain type of dummy liquid has been supplied to the flow path LP1, and a liquid to be treated is supplied to the flow path LP1 after generation of plasma. The dummy liquid is not treated by the plasma treatment and is used only for the purpose of creating a pressure-reduced state in the plasma generation region PG1.

### 5-8. Standing Wave

In the present embodiment, a standing wave is generated in the space K1 between the dielectric member 160 and the short plunger 170. In order that a strong electric field is applied between the first protrusion 121 and the second protrusion 131 at that time, the material of the dielectric member 160 and the distance between the dielectric member 160 and the short plunger 170 are selected appropriately.

### 5-9. Combination

The above-described modifications may be combined freely.

### 6. Summary of Present Embodiment

As having been described above, the plasma treatment apparatus 100 of the present embodiment can generate uniform circular plasma. Therefore, plasma treatment can be performed uniformly on the liquid flowing through the flow path LP1. In the present embodiment, plasma can be generated under reduced pressure without use of a pressure reducing pump or the like. Also, the liquid can be plasma-treated continuously in line rather than batch treatment.

### A. Supplementary Notes

The plasma treatment apparatus according to a first mode comprises a coaxial waveguide which includes an inner conductor, a first outer conductor located on the outer side of the inner conductor and having a first end portion, and a second outer conductor located on the outer side of the inner conductor and having a second end portion; a microwave generation unit which generates microwaves to be propagated to the coaxial waveguide; an outside tube which is located on the outer side of the first outer conductor and the second outer conductor and which in cooperation with the first outer conductor and the second outer conductor forms a flow path through which liquid flows; and a plasma generation region in which plasma is generated. The first end portion of the first outer conductor and the second end portion of the second outer conductor face each other in a non-contacting state. The plasma generation region is a region extending along a facing location where the first end portion of the first outer conductor and the second end portion of the second outer conductor face each other.

In the plasma treatment apparatus according to a second mode, the first outer conductor has a first protrusion protruding from the first end portion toward the second outer conductor. The second outer conductor has a second protrusion protruding from the second end portion toward the first outer conductor. The first protrusion and the second protrusion face each other in a non-contacting state.

In the plasma treatment apparatus according to a third mode, the first outer conductor has a first sloping surface formed on an outer peripheral portion of the first outer conductor so as to narrow the flow path down toward the first end portion.

In the plasma treatment apparatus according to a fourth mode, the second outer conductor has a second sloping surface formed on an outer peripheral portion of the second outer conductor so as to narrow the flow path down toward the second end portion.

The plasma treatment apparatus according to a fifth mode comprises a dielectric member in a region which extends along the facing location where the first end portion of the first outer conductor and the second end portion of the second outer conductor face each other and extends inward from the facing location.

In the plasma treatment apparatus according to a sixth mode, the dielectric member is disposed to extend from the first outer conductor and the second outer conductor to the inner conductor.

The plasma treatment apparatus according to a seventh mode comprises a plunger between the second outer conductor and the inner conductor.

In the plasma treatment apparatus according to an eighth mode, the direction of the center axis of at least one of the first outer conductor and the second outer conductor is parallel to the direction of the center axis of the outside tube.

### DESCRIPTION OF REFERENCE NUMERALS

100: plasma treatment apparatus
110: inner conductor
120: first outer conductor
121: first protrusion
122: first sloping surface
130: second outer conductor
131: second protrusion
132: second sloping surface
140: outside tube
150: microwave generation unit
160: dielectric member
170: short plunger
E1: first end portion
E2: second end portion
S1: slit
LP1: flow path
PG1: plasma generation region

1. A plasma treatment apparatus comprising:
a coaxial waveguide which includes an inner conductor, a first outer conductor located on the outer side of the inner conductor and having a first end portion, and a second outer conductor located on the outer side of the inner conductor and having a second end portion;
a microwave generation unit which generates microwaves to be propagated to the coaxial waveguide;
an outside tube which is located on the outer side of the first outer conductor and the second outer conductor and which in cooperation with the first outer conductor and the second outer conductor forms a flow path through which a liquid flows; and
a plasma generation region in which plasma is generated, wherein
the first end portion of the first outer conductor and the second end portion of the second outer conductor face each other in a non-contacting state, and
the plasma generation region is a region extending along a facing location where the first end portion of the first outer conductor and the second end portion of the second outer conductor face each other.

2. A plasma treatment apparatus according to claim 1, wherein the first outer conductor comprises a first protrusion protruding from the first end portion toward the second outer conductor, the second outer conductor comprises a second protrusion protruding from the second end portion toward the first outer conductor, and the first protrusion and the second protrusion face each other in a non-contacting state.

3. A plasma treatment apparatus according to claim 1, wherein the first outer conductor comprises a first sloping surface formed on an outer peripheral portion of the first outer conductor so as to narrow the flow path down toward the first end portion.

4. A plasma treatment apparatus according to claim 1, wherein the second outer conductor comprises a second sloping surface formed on an outer peripheral portion of the second outer conductor so as to narrow the flow path down toward the second end portion.

5. A plasma treatment apparatus according to claim 1, further comprising a dielectric member in a region which extends along the facing location where the first end portion of the first outer conductor and the second end portion of the second outer conductor face each other and extends inward from the facing location.

6. A plasma treatment apparatus according to claim 5, wherein the dielectric member is disposed to extend from the first outer conductor and the second outer conductor to the inner conductor.

7. A plasma treatment apparatus according to claim 1, further comprising a plunger between the second outer conductor and the inner conductor.

8. A plasma treatment apparatus according to claim 1, wherein a direction of a center axis of at least one of the first outer conductor and the second outer conductor is parallel to a direction of a center axis of the outside tube.

9. A plasma treatment apparatus according to claim 1, wherein the first end portion of the first outer conductor and the second end portion of the second outer conductor constitute a slit within a range of 0.05 mm to 1 mm.

10. A plasma treatment apparatus according to claim 1, wherein shapes of the first protrusion and the second protrusion are annular.
